(19) United States
(12) Patent Application Publication
(10) Pub. No.: US 2017/0003879 A1
(43) Pub. Date: Jan. 5, 2017

(54) PORTABLE TERMINAL AND CONTROL METHOD

(71) Applicant: KYOCERA CORPORATION, Kyoto (JP)

(72) Inventors: Naoyuki TAMAI, Takarazuka-shi (JP); Tomohiro SHIMAZU, Osaka (JP)

(21) Appl. No.: 15/267,031

(22) Filed: Sep. 15, 2016

Related U.S. Application Data
(63) Continuation of application No. 15/257,779, filed on Sep. 6, 2016, now abandoned.
Application No. 15/257,779 is a continuation of application No. PCT/JP2015/086367, filed on Dec. 25, 2015.

(30) Foreign Application Priority Data
Dec. 25, 2014 (JP) 2014-262162

(51) Int. Cl. G06F 3/0489; H04M 1/725; G01C 5/06; G06F 3/02; G06F 3/023; G01B 13/14; H04B 1/3827; G06F 3/0481

(52) U.S. Cl. CPC G06F 3/04895; H04B 1/3833; H04M 1/72569; H04M 1/7258; H04M 1/72583; G06F 3/0481; G06F 3/0227; G06F 3/0238; G01B 13/14; G01C 5/06; H04B 2001/3894

(57) ABSTRACT

A portable telephone includes at least one processor and the at least one processor detects a barometric pressure value (a water pressure value) based on an output from a pressure sensor. In an underwater mode, a touch panel is turned off and a function for an underwater operation is allocated to a hardware key. A guide image for notification of a function different from a function for use in atmosphere is shown in correspondence with a hardware key to which the function is allocated, on a screen shown during execution of the function.

### CROSS-REFERENCE TO RELATED APPLICATION

The present application is a continuation application of U.S. patent application Ser. No. 15/257,779, filed Sep. 6, 2016, which is a continuation application based on PCT Application No. PCT/JP2015/086367 filed on Dec. 25, 2015, which claims the benefit of Japanese Application No. 2014-262162 filed on Dec. 25, 2014. PCT Application No. PCT/JP2015/086367 is entitled “Portable Terminal and Control Method,” and Japanese Application No. 2014-262162 is entitled “Portable Terminal and Control Method,” the contents of which are incorporated by reference herein in their entireties.

### FIELD

The present disclosure relates to a portable terminal and a method of controlling the same.

### BACKGROUND

In a portable electronic device according to the background, a control unit regards input operations onto a hard key operation portion and a touch panel both as valid when a value output from a pressure sensor is not greater than a reference value indicating an atmospheric pressure. When a value output from the pressure sensor is greater than the reference value, it is determined that the portable electronic device is under water, an input operation onto the touch panel is regarded as invalid, and an input operation onto the hard key operation portion is regarded as valid.

### SUMMARY

A manner of the present disclosure adopts features below in order to solve the problem above. A reference numeral and supplementary explanation in parentheses show correspondence with an embodiment described for assisting understanding of the present disclosure and do not limit the present disclosure.

A portable terminal according to one manner of the present disclosure is provided with a waterproof function. The portable terminal includes a display, a touch panel located in association with the display, at least one hardware key, and at least one processor. The at least one processor is configured to determine whether or not the portable terminal is under water and to cause the display to show a guide image for notification of a function for underwater use in correspondence with the hardware key to which the function is allocated when the portable terminal is determined to be under water.

A storage medium according to one manner of the present disclosure is a processor readable storage medium having a control program stored thereon, the control program having at least one processor control a portable terminal with a waterproof function, the portable terminal including a display, a touch panel located in association with the display, and at least one hardware key. The control program can have at least one processor determine whether or not the portable terminal is under water and cause the display to show a guide image for notification of a function for underwater use in correspondence with the hardware key to which the function is allocated when the portable terminal is determined to be under water.

A control method according to one manner of the present disclosure is a method of controlling a portable terminal with a waterproof function, the portable terminal including a display, a touch panel located in association with the display, and at least one hardware key. The at least one processor of the portable terminal is configured to determine whether or not the portable terminal is under water and to cause the display to show a guide image for notification of a function for underwater use in correspondence with the hardware key to which the function is allocated when the portable terminal is determined to be under water.

The foregoing and other objects, features, aspects and advantages of the present disclosure will become more apparent from the following detailed description of examples when taken in conjunction with the accompanying drawings.

### BRIEF DESCRIPTION OF THE DRAWINGS

FIG. 1 is an external view showing one example of appearance of a portable telephone in one example.

FIG. 2 is an illustrative diagram showing an electrical configuration of the portable telephone shown in FIG. 1.

FIG. 3 is a diagram showing one example of a home screen shown on a display in a normal mode.

FIG. 4 is a diagram showing one example of a home screen shown on the display in an underwater mode.

FIG. 5 is a diagram showing one example of a shot screen shown on the display in the normal mode.

FIG. 6 is a diagram showing one example of a shot screen shown on the display in the underwater mode.

FIG. 7 is a diagram showing one example of a view screen shown on the display in the normal mode.

FIG. 8 is a diagram showing one example of a view screen shown on the display in the underwater mode.

FIG. 9 is a diagram showing one example of a distance measurement screen shown on the display in the normal mode.

FIG. 10 is a diagram showing one example of a distance measurement screen shown on the display in the underwater mode.

FIG. 11 is a diagram showing one example of a light operation screen shown on the display in the normal mode.

FIG. 12 is a diagram showing one example of a light operation screen shown on the display in the underwater mode.

FIG. 13 is a diagram showing one example of a memory map in a RAM shown in FIG. 2.

FIG. 14 is a flowchart showing home screen representation processing by at least one processor shown in FIG. 2.

FIG. 15 is a flowchart showing mode switching processing by at least one processor shown in FIG. 2.

FIG. 16 is a flowchart showing camera processing by at least one processor shown in FIG. 2.

FIG. 17 is a flowchart showing processing in accordance with a touched icon or a key operation by at least one processor shown in FIG. 2 in the normal mode of the camera processing shown in FIG. 16.

FIG. 18 is a flowchart showing processing in accordance with a key operation by at least one processor shown in FIG. 2 in the underwater mode of the camera processing shown in FIG. 16.

### DETAILED DESCRIPTION

An embodiment will be described below with reference to the drawings.

According to the portable electronic device in the background, whether or not the portable electronic device is under water is determined based on a value output from the pressure sensor. When the portable electronic device is under water, an input operation onto the touch panel is simply regarded as invalid and an input operation onto the hard key operation portion is simply regarded as valid.

In the portable electronic device according to the background, the control unit may change allocation of a function to an operation key between a case that a value output from the pressure sensor exceeds the reference value and a case otherwise. How the change is made, however, is not clearly described, and in addition, how a user identifies the allocated function is unclear.

Therefore, for example, the user has to check which function is allocated to which operation key while the user operates the hard key operation portion. Alternatively, the user has to read in advance an operation manual. Since such a portable electronic device can execute a plurality of applications, it has been bothersome to do checking for each application. The problem as such can be solved by the disclosure below.

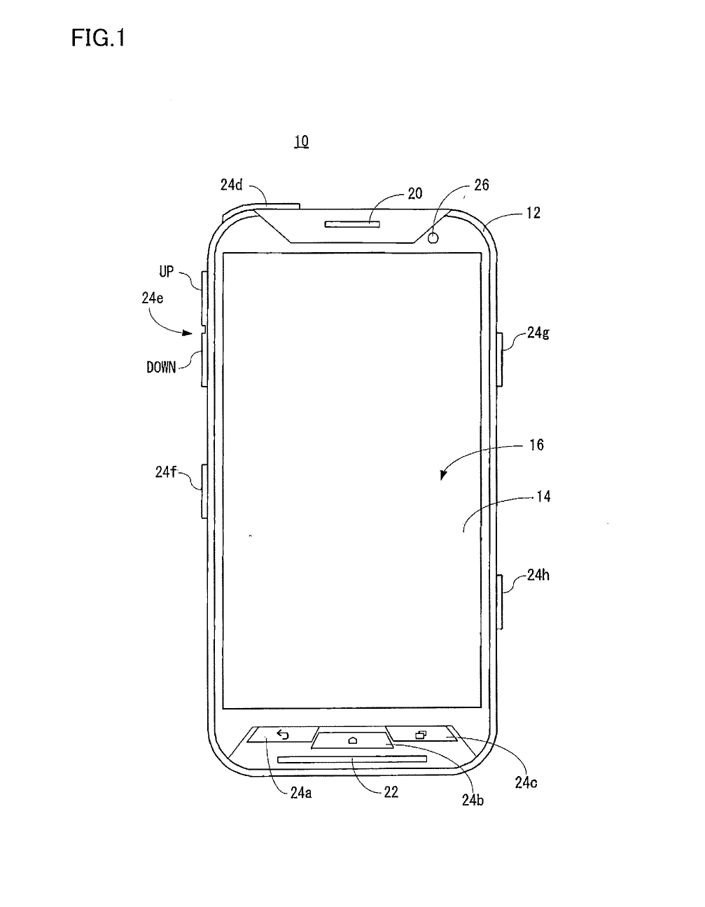

Referring to FIG. 1, a portable telephone 10 in one example is a smartphone by way of example and held by a user. Portable telephone 10 in this example is a multi-functional information terminal with a waterproof function, and some functions can be executed (used) also under water.

The present disclosure is applicable not only to portable telephone 10 but also to any portable terminals such as a tablet terminal, a tablet PC, and a PDA.

The waterproof function itself has been well known and is not the essential feature of the present disclosure. Therefore, description of the waterproof function will not be provided.

As shown in FIG. 1, portable telephone 10 includes, for example, a housing 12 which is in a vertically long, flat rectangular shape. A display 14 is located on a main surface (a front surface) of housing 12. For example, display 14 includes a liquid crystal or an organic EL. For example, a touch panel 16 is located on display 14.

A speaker 20 is contained at one end (an upper end) in a longitudinal direction of housing 12 and a microphone 22 is contained on a main surface side at the other end (a lower end) in the longitudinal direction. On the main surface and side surfaces of housing 12, hardware keys (hereinafter simply called a “key”) 24a, 24b, 24c, 24d, 24e, 24f, 24g, and 24h which function as input modules or operation modules together with touch panel 16 are located. Specifically, keys 24a, 24b, and 24c are located side by side on the main surface of housing 12 below display 14. Key 24d is located at a left end portion of a top surface (an upper side surface) of housing 12. Key 24e and key 24f are located on a left side surface of housing 12. On the left side surface of housing 12, key 24e is located at an upper end portion and key 24f is located in a central portion. Key 24g and key 24h are located on a right side surface of housing 12. On the right side surface of housing 12, key 24g is located slightly above a central portion and key 24h is located slightly below the central portion.

Arrangement and the number of keys 24a to 24h are by way of example and do not have to be limited to those for portable telephone 10 in the example but can be modified as appropriate. Functions allocated to keys 24a to 24h which will be described later are also by way of example and should not be limited but can be modified as appropriate depending of specifications of an actual product.

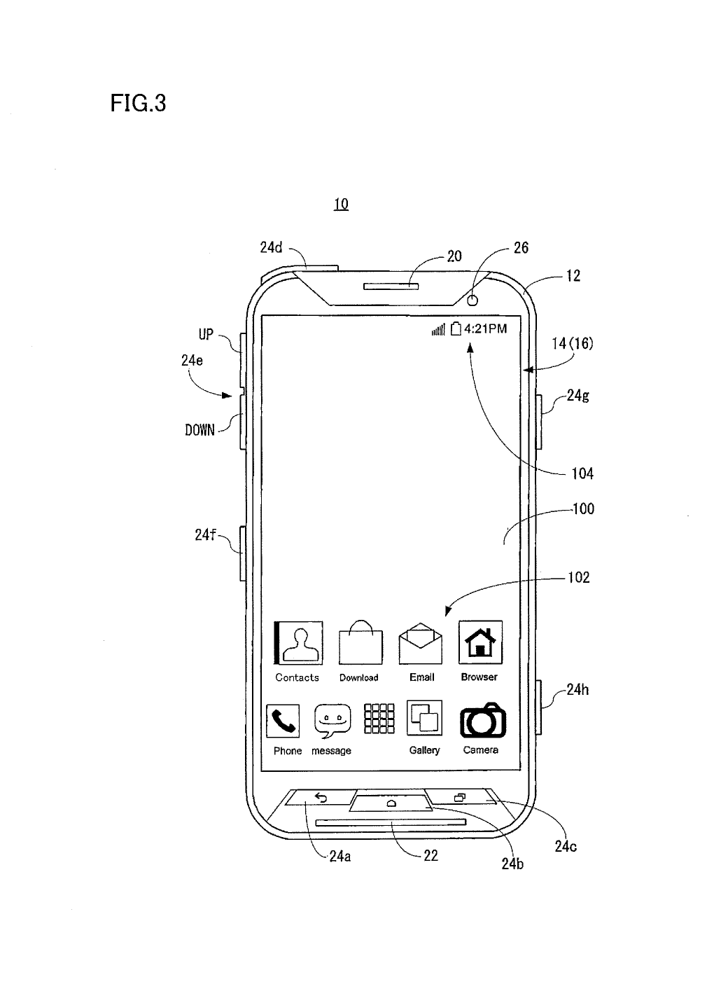

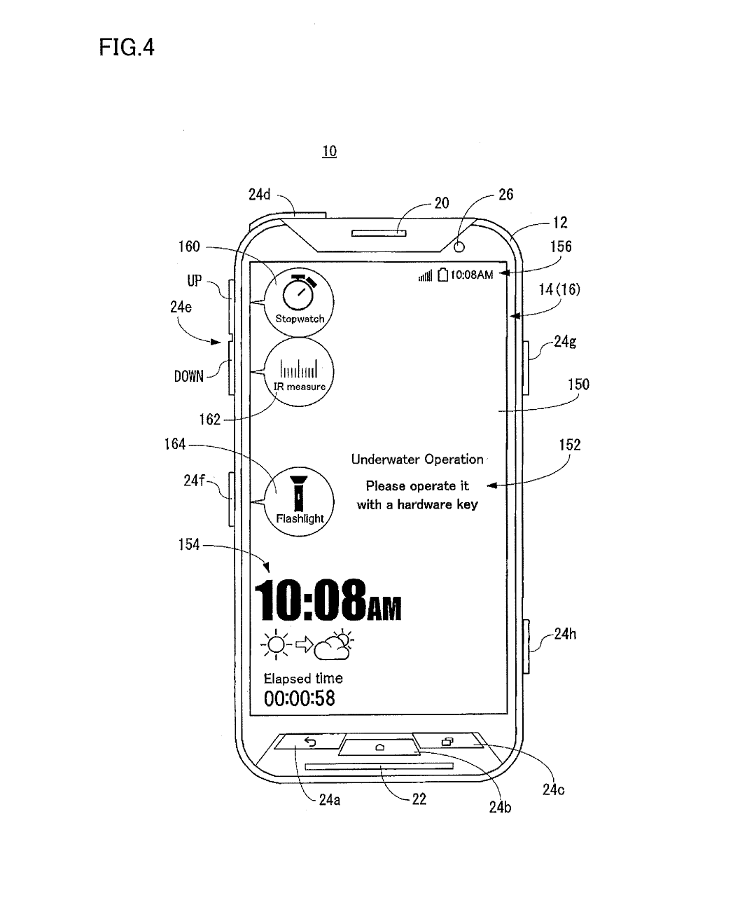

Key 24a is a back key and can be used for showing an immediately preceding screen (returning to the immediately preceding screen). Key 24b is a home key and can be used for showing a home screen (see FIGS. 3 and 4). Key 24c is a menu key and can be used for showing a menu for options for a currently shown screen.

Key 24d is a key for switching of speaker 20 and can be used for switching between an ear speaker and a handsfree speaker. In this example, speaker 20 serves as both of the ear speaker and the handsfree speaker, and can be switched between a sound volume for call reception and a sound volume for handsfree use by adjusting a gain of speaker 20.

Key 24e is a volume key and can be used for adjusting a sound volume. Key 24e can be constituted of an UP key and a DOWN key. When the UP key is operated, the sound volume can be turned up, and when the DOWN key is operated, the sound volume can be turned down. The sound volume can be adjusted between a maximum value and a minimum value.

Key 24f is a push-to-talk (PTT) conversation key and can be used when something is said (uttered) in a PTT call. Key 24g is a power key and can be used for turning on and off of a main power supply of portable telephone 10. Key 24h is a camera key and can be used for executing a camera function (a camera application).

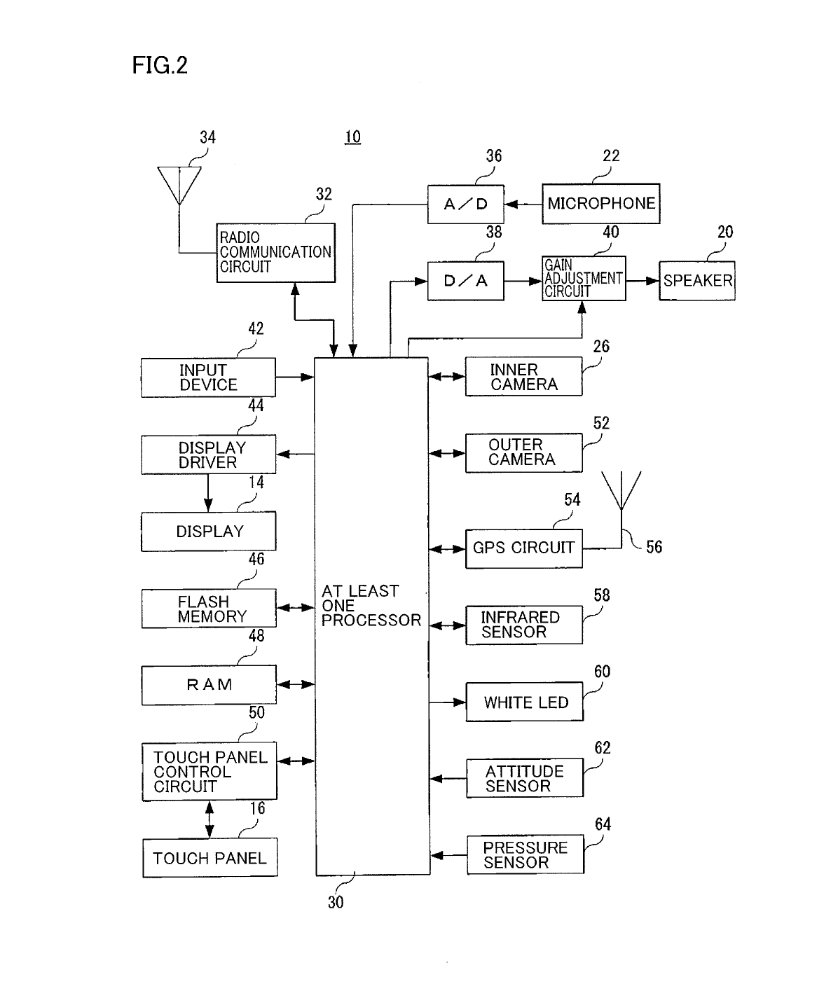

A camera (inner camera) 26 can be located in the front surface of housing 12 on the right of speaker 20. Though not shown in FIG. 1, an outer camera 52 (see FIG. 2) can be located in a rear surface of housing 12 (a surface opposite to the front surface).

FIG. 2 is a block diagram showing one example of an electrical configuration of portable telephone 10 shown in FIG. 1. As shown in FIG. 2, portable telephone 10 includes at least one processor 30. Inner camera 26 described above is connected to at least one processor 30, and a radio communication circuit 32, an A/D converter 36, a D/A converter 38, a gain adjustment circuit 40, an input device 42, a display driver 44, a flash memory 46, a RAM 48, a touch panel control circuit 50, outer camera 52, a GPS circuit 54, an infrared sensor 58, a white LED 60, an attitude sensor 62, and a pressure sensor 64 can be connected thereto.

An antenna 34 can be connected to radio communication circuit 32, microphone 22 can be connected to A/D converter 36, and speaker 20 can be connected to D/A converter 38 with gain adjustment circuit 40 being interposed. Display 14 can be connected to display driver 44, and touch panel 16 can be connected to touch panel control circuit 50. A GPS antenna 56 can be connected to GPS circuit 54.

At least one processor 30 is also called a computer or a CPU and can be responsible for overall control of portable telephone 10. In accordance with various embodiments, at least one processor 30 may be implemented as a single integrated circuit (IC) or as multiple communicatively coupled IC's and/or discrete circuits. It is appreciated that at least one processor 30 can be implemented in accordance with various known technologies.

In one embodiment, at least one processor 30 includes one or more circuits or units configurable to perform one or more data computing procedures or processes. For example, at least one processor 30 may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described below.

Flash memory 46 can function as a storage module and can save a control program for portable telephone 10 or various types of data necessary for execution of the control program. RAM 48 can function as a storage module and can be used as a work area or a buffer area of at least one processor 30. The entirety or a part of a control program stored in flash memory 46 can be developed on (written in) RAM 48 during use. At least one processor 30 can operate in accordance with the control program on RAM 48. RAM 48 can also store data necessary for execution of the control program. Flash memory 46 corresponds to one example of a processor readable storage medium having a control program stored thereon, the control program having at least one processor control a portable terminal. The storage medium may be a medium which stores a program in a non-volatile manner such as a universal serial bus (USB) memory and a secure digital (SD) memory card.

Input device 42 includes keys 24a to 24h shown in FIG. 1 and can accept key operations onto keys 24a to 24h. Information from keys 24a to 24h (key data) at which key operations have been accepted can be input to at least one processor 30 through input device 42.

Radio communication circuit 32 is a circuit configured to transmit and receive radio waves for a voice call or a mail through antenna 34. In an example, radio communication circuit 32 is a circuit configured for radio communication under CDMA. For example, based on an operation for placing a call (an outgoing call) accepted by touch panel 16, radio communication circuit 32 can perform outgoing call processing under instructions from at least one processor 30 and output an outgoing call signal through antenna 34. The outgoing call signal is transmitted to a called telephone through a base station and a communication network. When incoming call processing is performed in the called telephone, a communication allowable state is established and at least one processor 30 can perform conversation processing. Radio communication circuit 32 may adapt to other communication schemes such as LTE instead of CDMA.

A/D converter 36 can convert an analog audio signal obtained through microphone 22 into digital audio data and can input the audio data to at least one processor 30. D/A converter 38 can convert digital audio data into an analog audio signal and provide the audio signal to speaker 20 through gain adjustment circuit 40 so that voice and sound based on the audio data is output from speaker 20. While conversation processing is performed, voice and sound collected by microphone 22 can be transmitted to a called telephone and voice and sound collected in the called telephone can be output from speaker 20. A sound volume of speaker 20 can be adjusted by gain adjustment circuit 40. Gain adjustment circuit 40 can switch between a sound volume (a sound pressure level) for call reception and a sound volume (a sound pressure level) for a handsfree call in accordance with an operation of key 24d under instructions from at least one processor 30. Gain adjustment circuit 40 can vary a sound volume within a control range of a sound volume for call reception or vary a sound volume within a control range of a sound volume for a handsfree call in accordance with an operation of key 24e.

Display 14 can show a video image or an image in accordance with video data or image data output from at least one processor 30. For example, display driver 44 includes a video memory configured to temporarily store video data or image data for showing on display 14. The video data or the image data output from at least one processor 30 is stored in the video memory. Display driver 44 can have display 14 show a video image or an image in accordance with contents in the video memory. Display driver 44 can control representation on display 14 connected to display driver 44 under instructions from at least one processor 30. Display 14 is located with a backlight, and display driver 44 can control brightness and turn-on and off of the backlight in accordance with instructions from at least one processor 30.

Touch panel control circuit 50 can provide a voltage necessary for touch panel 16. Touch panel control circuit 50 can input to at least one processor 30, a touch start signal indicating start of touch onto touch panel 16, an end signal indicating end of touch, and coordinate data indicating a position of touch (a touch position). At least one processor 30 can determine a touched object based on input coordinate data and variation in coordinate data. An object herein means a GUI such as an icon or a software key shown on display 14.

Touch panel 16 is a general-purpose touch panel, and a touch panel of any type such as a capacitance type, an electromagnetic induction type, a resistive film type, and an infrared type can be employed. In this example, a touch panel of a capacitance type is employed as touch panel 16.

A touch operation (a touch input) in this example includes a tap operation, a long tap operation, a flick operation, and a swipe (slide) operation.

The tap operation refers to an operation to touch a surface of touch panel 16 with a finger and thereafter remove (release) the finger from the surface of touch panel 16 in a short period of time. The long tap operation refers to an operation to keep a finger in contact with the surface of touch panel 16 and thereafter remove the finger from the surface of touch panel 16. The flick operation refers to an operation to touch the surface of touch panel 16 with a finger and flick the finger at a prescribed speed or higher in any direction. The swipe operation refers to an operation to move a finger in any direction while the finger is in contact with the surface of touch panel 16 and thereafter remove the finger from the surface of touch panel 16.

The swipe operation also includes a swipe operation called a drag operation to touch an object shown on the surface of display 14 with a finger and to move the object. An operation to perform a drag operation and thereafter remove a finger from the surface of touch panel 16 is called a drop operation.

The touch operation can be performed also with a stylus pen.

Inner camera 26 and outer camera 52 are image pick-up devices including such image pick-up elements as a CCD or a CMOS. As a camera application (camera processing) is executed, inner camera 26 can be activated. As a user inputs a switching instruction, inner camera 26 can be inactivated and outer camera 42 can be activated. As the user inputs a switching instruction, outer camera 52 can be inactivated and inner camera 26 can be activated.

Image pick-up devices such as inner camera 26 and outer camera 52 have been well known and operations thereof are not essential contents of the present disclosure. Therefore, description of operations of the image pick-up devices will not be provided.

GPS circuit 54 can be activated when a current position is determined with a GPS function. GPS circuit 54 can perform positioning processing based on a GPS signal from a GPS satellite when the GPS signal received by GPS antenna 56 is input. Consequently, a latitude, a longitude, and an altitude (a height) can be calculated as GPS information (position information).

In determination of a current position with the GPS function, in addition to a GPS signal transmitted from a GPS satellite, a signal transmitted from a base station or a signal transmitted from an access point of wireless LAN can also be made use of.

Infrared sensor 58 is a general-purpose distance sensor and can be constituted of an infrared LED and a light reception element (a position sensitive detector (PSD)). Infrared sensor 58 can measure a distance from an object by making use of principles of triangulation. Infrared rays emitted from an infrared LED are reflected by the object. Reflected infrared light is received by the light reception element. A position of reflected infrared light (a light reception position) varies depending on a distance from the object. A resistance value of the position sensitive detector varies depending on the light reception position, and a distance from the object is obtained as a resistance value.

White LED 60 is a white LED lamp. In response to an instruction from a user, at least one processor 30 can turn on and off white LED 60, has white LED 60 to blink, and adjust brightness thereof.

Attitude sensor 62 is a sensor obtained by integrating a gyro sensor configured to detect rotation (angular velocity) around three axes (X, Y, Z) in portable telephone 10 and an acceleration sensor configured to detect an acceleration in directions of three axes (X, Y, Z) in portable telephone 10 with the micro electro mechanical systems (MEMS) technique. Therefore, attitude sensor 62 may also be referred to as a 6-axis motion sensor. At least one processor 30 can detect an inclination (an angle) or motion of portable telephone 10 based on an angular velocity along the three axes and an acceleration in directions of three axes output from attitude sensor 62.

For example, when display 14 shows some kind of a screen, an attitude in which portable telephone 10 is held is detected by making use of an angular velocity and an acceleration, and a direction of representation is set in accordance with the detected attitude. In this example, a direction of representation is set to vertical when portable telephone 10 is held in a vertical attitude and a direction of representation is set to horizontal when portable telephone 10 is held in a horizontal attitude.

In other examples, an acceleration sensor and/or a gyro sensor may be included instead of attitude sensor 62.

Pressure sensor 64 is a sensor configured to detect a pressure applied to portable telephone 10. In this example, a general-purpose barometric pressure sensor is employed as pressure sensor 64. The barometric pressure sensor is a semiconductor pressure sensor and can detect an ambient barometric pressure with the use of an internally piezoresistive element. At least one processor 30 can convert an output from the barometric pressure sensor into a barometric pressure value (a water pressure value). An output from the barometric pressure sensor results from conversion of variation in electrical resistance owing to a piezoresistive effect into an electric signal. In this example, at least one processor 30 can determine whether portable telephone 10 is under water or in air (in atmosphere) by making use of a barometric pressure value (a water pressure value).

Though a barometric pressure sensor is employed as pressure sensor 64 in this example, a water pressure sensor may be employed.

As described above, portable telephone 10 can execute some applications even under water. In a conventional portable telephone with a waterproof function, under water, in order to prevent an erroneous operation of touch panel 16, various operations are performed with touch panel 16 being inactivated and with hardware keys being activated.

In the conventional portable telephone with the waterproof function, however, hardware keys are simply used under water and which function is allocated to which hardware key is unknown. Therefore, for example, a user has to check a function by operating a hardware key or check an operation manual in advance. Since such a portable telephone is a multi-functional information terminal and can execute a plurality of applications, it has been bothersome to do checking for each application and operability has been poor.

In an example, whether portable telephone 10 is in atmosphere or under water is determined. When the portable telephone is under water (in an underwater mode), an operation guide is shown so that functions allocated to keys 24a to 24h can be known. Therefore, a screen different from a screen shown when portable telephone 10 is in atmosphere (in a normal mode) is shown in the underwater mode.

Functions allocated to keys (24a to 24h) herein may mean functions set in advance for operating portable telephone 10 (default functions), applications executable by portable telephone 10, and an operation for each application (an input instruction) as described above.

FIG. 3 shows one example of a home screen 100 shown on display 14 in the normal mode. On home screen 100, icons 102 for functions executable in the normal mode are shown. As can be seen also in FIG. 3, for example, icons 102 are shown for executing various functions including contacts, download, e-mail, browser, phone, short message, selection of other applications, gallery, and camera. Information 104 on intensity of radio waves, a state of charge of a battery, and current time is shown in an upper right portion of home screen 100 with an image and characters.

As described above, functions are allocated to keys 24a and 24h in advance and the functions allocated in advance can be executed in the normal mode. In the normal mode, touch panel 16 can be used. A desired function (application) can be executed by touching icon 102 indicating the function. This is applicable also to the normal mode where another application is executed.

FIG. 4 shows one example of a home screen 150 shown on display 14 in the underwater mode. In the underwater mode, functions executable even under water are allocated to keys 24a to 24h. A stopwatch function is allocated to the UP key of key 24e, a function for measuring a distance is allocated to the DOWN key of key 24e, and a flashlight function is allocated to key 24f. In this example, a function common to the normal mode and the underwater mode is allocated to each of key 24g and key 24h. Key 24g is used to turn on and off power and key 24h is used to execute the camera function.

Thus, in the underwater mode, functions executable only in atmosphere (normal mode) are not allocated to keys 24a to 24h. Under water, functions for telephone and data communication cannot be executed. Specifically, functions for download, e-mail, browser, phone, and short message cannot be executed. Since the GPS function cannot be used either, for example, a function for navigation using this function cannot be executed either.

Referring back to FIG. 4, a message 152 indicating an operation under water (Underwater Operation) and indicating that an operation is to be performed with a hardware key (Please operate it with a hardware key) is shown in the center of home screen 150. In a lower left portion of the screen, information 154 on current time, today's weather, and an elapsed time since entry into water is shown with an image and characters. In the upper right portion of home screen 150, information 156 on intensity of radio waves, a state of charge of the battery, and current time is shown with an image and characters.

As described above, functions different from those in the normal mode are allocated to the UP key and the DOWN key (key 24e) and key 24f. Therefore, guide images 160, 162, and 164 for notification of functions allocated in the underwater mode are shown on home screen 150. Guide image 160 shows a graphic representing a stopwatch function and is shown in correspondence with the UP key. Guide image 160 is substantially annular and a part of the circumference protrudes so as to point to the UP key. This is also applicable to other guide images (162, 164, 254, 258, 260, 262, 358, 360, 362, 454, 456, 458, 552, 554, 556, and 558).

A design of a guide image is by way of example and other designs may be adopted so long as a corresponding key (24a to 24h) can be identified.

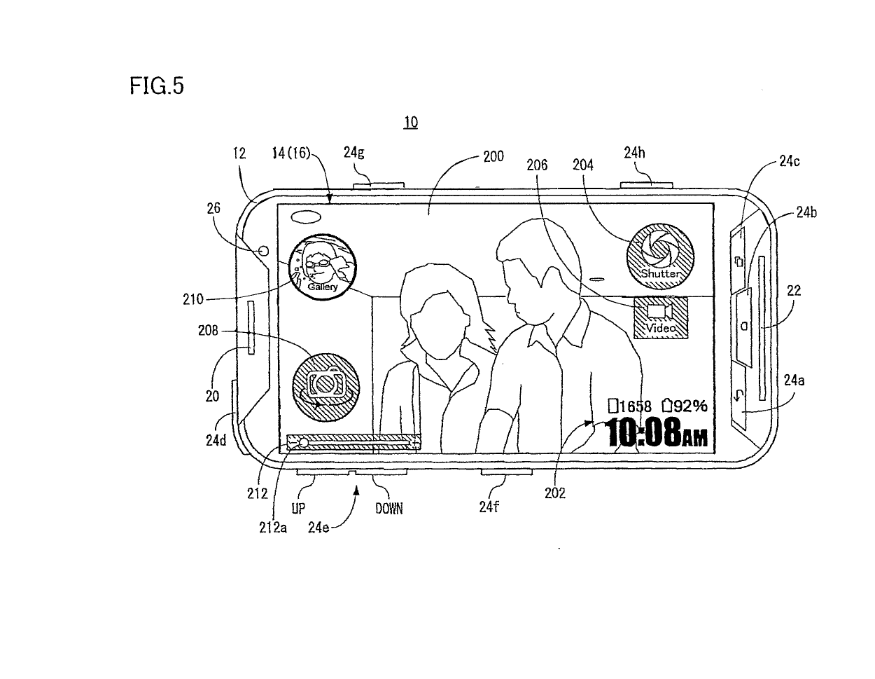

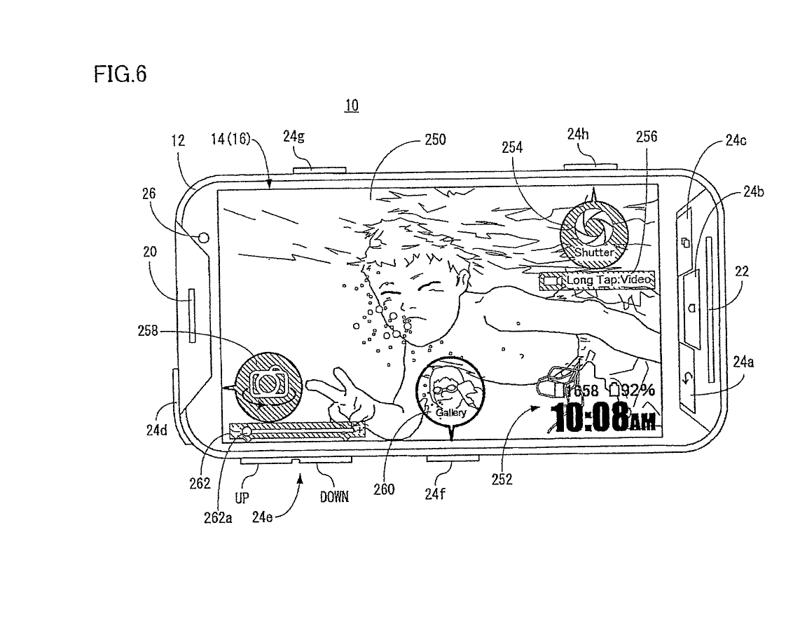

FIG. 5 shows one example of a shot screen 200 shown on display 14 when the camera function is executed in the normal mode. FIG. 5 (and FIGS. 6 to 8) shows an example of shot screen 200 when portable telephone 10 is horizontally held. Whether or not portable telephone 10 is horizontally held can be determined based on angular velocity data and acceleration data input from attitude sensor 62.

For example, the camera function can be executed when icon 102 shown with an image of a camera is touched on home screen 100 or when key 24h is operated (pressed) while home screen 100 or home screen 150 is shown on display 14.

Referring back to FIG. 5, shot screen 200 is generally shown as a through image, and information 202 on the number of remaining still image shots, a state of charge of the battery, and current time is shown in front of and in a lower right portion of the through image. Icons 204, 206, 208, 210, and 212 for operations in the normal mode are shown in front of the through image.

Icon 204 is a virtual shutter button for shooting and icon 206 is a virtual switch button for switching between shooting modes. When icon 206 is touched in a mode for shooting a still image, switching to a mode for shooting moving images can be made. When icon 206 is touched in a mode for shooting an operation image, switching to a mode for shooting a still image can be made. For example, an image indicating a shooting mode resulting from switching is shown as icon 206. An image displayed as icon 206 can also be switched in accordance with switching between the shooting modes.

Icon 208 is a virtual button for switching between cameras to be used. In this example, switching between inner camera 26 and outer camera 52 can be made. When icon 208 is touched while inner camera 26 is used, inner camera 26 can be inactivated and outer camera 52 can be activated. When icon 208 is touched while outer camera 52 is used, outer camera 52 can be inactivated and inner camera 26 can be activated.

Icon 210 is a virtual button for executing a function to view photographs. When icon 210 is touched, the camera function can be quitted and a function to view photographs can be executed (started) as will be described later. With the function to view photographs, shot still images or moving images and obtained (downloaded) still images or moving images can be viewed.

Icon 212 is a virtual button for setting zoom. A slide button 212a is shown together with icon 212 so that zoom can be set by sliding slide button 212a. For example, when slide button 212a is slid toward +, an image is zoomed in, and when slide button 212a is slid toward −, an image is zoomed out.

FIG. 6 shows one example of a shot screen 250 shown on display 14 when the camera function is executed in the underwater mode. In the underwater mode, functions allocated to icons 204 to 212 are allocated to keys 24d, 24e, 24f, and 24h. Specifically, the function to switch between cameras is allocated to key 24d. For key 24e, a zoom-out function is allocated to the UP key and a zoom-in function is allocated to the DOWN key. A function to view photographs is allocated to key 24f. A shutter function and a function to switch between shooting modes are allocated to key 24h. In this example, when key 24h is pressed for a time period shorter than a certain period (for example, 2 seconds), shooting can be performed, and when key 24h is pressed and held for a period exceeding the certain period, switching between shooting modes can be made.

In shot screen 250 shown in FIG. 6, guide images 254, 256, 258, 260, and 262 for notification of functions allocated to keys 24d, 24e, 24f, and 24h are shown in front of the through image. Since guide images 254, 260, and 262 are similar to guide images 160 to 164 described in connection with home screen 150, redundant description will not be provided.

Guide image 256 is a horizontally long rectangular image and shown adjacently below guide image 254. When guide image 256 is pressed and held, switching between the shooting modes is made. Here, switching to the mode for shooting moving images is made.

Guide image 262 is also a horizontally long rectangular image and indicates the UP key and the DOWN key with a part of an outer circumference thereof protruding. When the UP key is operated, an image is zoomed out, and when the DOWN key is operated, the image is zoomed in. An annular button image shown in guide image 262 is moved to the left in response to an operation of the UP key and to the right in response to an operation of the DOWN key so as to indicate a degree of zoom.

In the lower right portion of shot screen 250, information 252 on the number of remaining still image shots, a state of charge of the battery, and current time is shown as in shot screen 200.

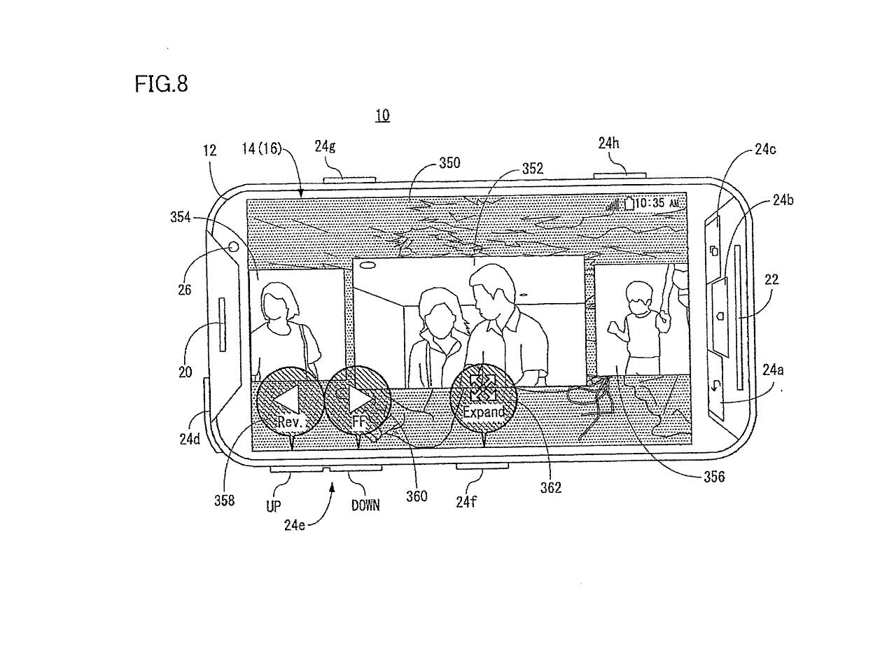

In shot screen 250, a message informing that the mode is set to the underwater mode, for example, message 152 indicating an operation under water (Underwater Operation) and indicating that an operation is to be performed with a hardware key (Please operate it with a hardware key) shown in FIG. 4, may be shown. This is also applicable to a view screen 350 in FIG. 8 which will be described later.

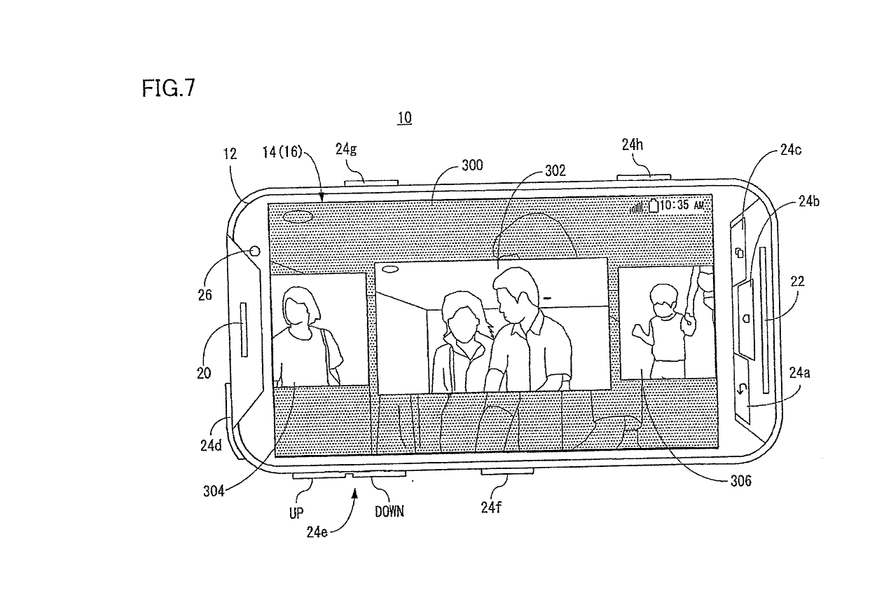

FIG. 7 shows one example of a view screen 300 shown on display 14 when the function to view photographs is executed during execution of the camera function in the normal mode.

For example, the viewing function can be executed by touching icon 102 shown with an image of two layered quadrangles on home screen 100 or touching icon 210 on shot screen 200. The viewing function can be executed when key 24f is operated while shot screen 250 is shown on display 14.

In view screen 300, thumbnail images of shot images and obtained images are shown in a manner slidable (scrollable) in a lateral direction. In view screen 300 shown in FIG. 7, images 302, 304, and 306 are shown side by side. For example, when image 302 shown in the center is touched, image 302 is shown as being zoomed in over the entire representation area of display 14. When the image as being zoomed in is touched again, the image returns to the original size. When another image is to be viewed, a user scrolls view screen 300 in the lateral direction by sliding view screen 300 to the left or right. Alternatively, a plurality of images arranged in the lateral direction are moved in the lateral direction by sliding of the view screen to the left or right by a user.

Since the camera function has been inactivated, taking in of a through image is also inactivated and a through image at the time point when the camera function was inactivated is dimly shown as the background. This is also applicable to view screen 350 in the underwater mode.

FIG. 8 shows one example of view screen 350 shown on display 14 when the function to view photographs is executed during execution of the camera function in the underwater mode. In the underwater mode, a function to scroll a screen or to move images is allocated to key 24e, and a function to zoom in/out an image is allocated to key 24f. A function to scroll a screen to the right (to move an image to the left) is allocated to the UP key and a function to scroll a screen to the left (to move an image to the right) is allocated to the DOWN key.

In view screen 350 shown in FIG. 8, guide images 358, 360, and 362 for notification of functions allocated to key 24e and key 24f are shown in front of the background which is a dimly shown through image at the time when the camera function was inactivated. Since these guide images 358 to 362 are similar to guide images 160 to 164 described in connection with home screen 150, redundant description will not be provided.

In this view screen 350 as well, thumbnail images of shot images and obtained images are shown in a manner slidable (scrollable) in the lateral direction as in view screen 300 in the normal mode.

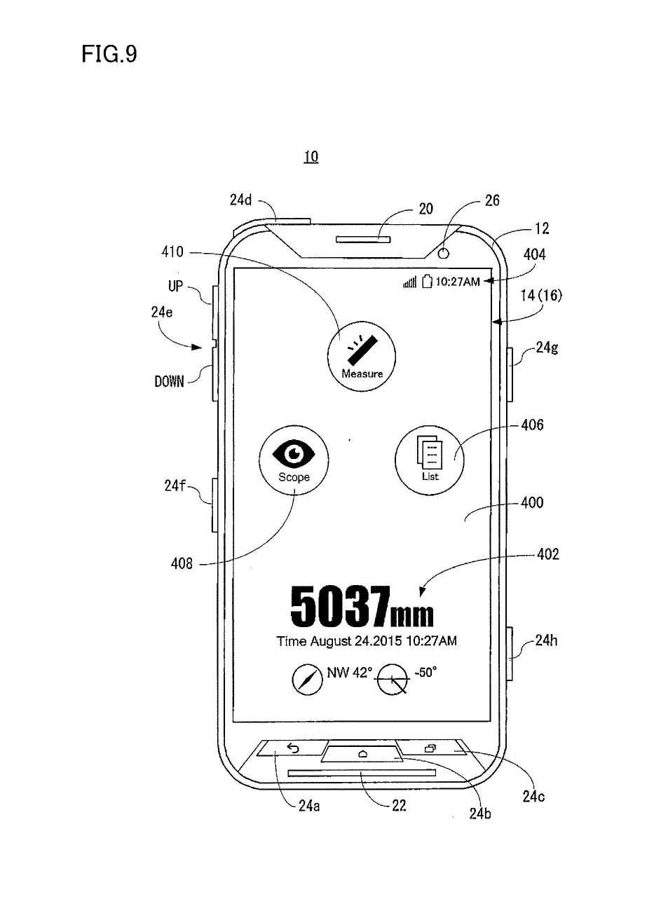

FIG. 9 shows one example of a distance measurement screen 400 shown on display 14 when a distance measurement function is executed in the normal mode.

For example, when icon 102 shown with an image consisting of a plurality of quadrangles is touched on home screen 100, a function to select other applications can be executed. When an icon for a distance measurement function is touched in a screen in which icons indicating other applications are shown on display 14 in a list or when the DOWN key of key 24e is operated while home screen 150 is shown on display 14, the distance measurement function can be executed.

In distance measurement screen 400, information 402 on a measured distance, time and day of measurement (including month and year), an azimuth, and an orientation of portable telephone 10 is shown in a lower end portion of the screen with an image and characters. Information 404 on intensity of radio waves, a state of charge of the battery, and current time is shown in the upper right portion of distance measurement screen 400 with an image and characters. Icons 406, 408, and 410 for operations in the normal mode are shown on distance measurement screen 400.

Icon 410 is a button for starting (conducting) measurement. Icon 406 is a button for showing a history of measurement. Icon 408 is a button for executing a nightscope. For example, a nightscope is a function for notification of sensing of such a creature as fish.

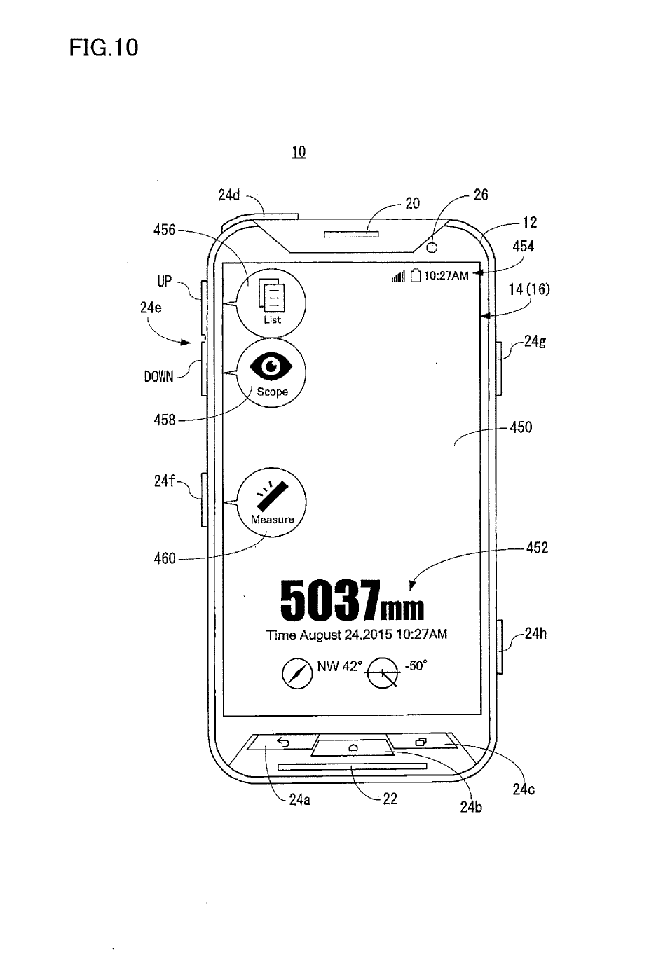

FIG. 10 shows one example of a distance measurement screen 450 shown on display 14 when the distance measurement function is executed in the underwater mode. In the underwater mode, a function to show a history of measurement is allocated to the UP key of key 24e and a function to execute the nightscope is allocated to the DOWN key of key 24e.

In distance measurement screen 450 shown in FIG. 10, guide images 456, 458, and 460 for notification of functions allocated to key 24e and key 24f are shown. Since guide images 456 to 460 are similar to guide images 406 to 410 described in connection with home screen 150, redundant description will not be provided.

In distance measurement screen 450 as well, information 452 on a measured distance, time and day of measurement (including month and year), an azimuth, and an orientation of portable telephone 10 is shown in the lower end portion of the screen with an image and characters as in distance measurement screen 400 in the normal mode. Information 454 on intensity of radio waves, a state of charge of the battery, and current time is shown in the upper right portion of distance measurement screen 450 with an image and characters.

In distance measurement screen 450 as well, a message informing that the mode is set to the underwater mode, for example, message 152 indicating an operation under water (Underwater Operation) and indicating that an operation is to be performed with a hardware key (Please operate it with a hardware key) shown in FIG. 4, may be shown.

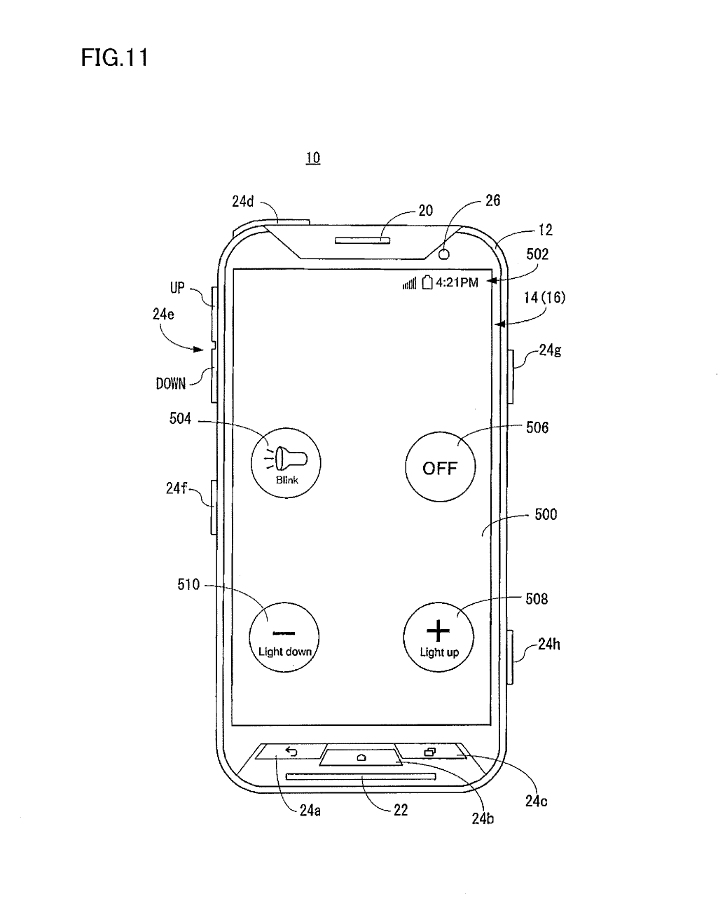

FIG. 11 shows one example of a light operation screen 500 shown on display 14 when a flashlight function is executed in the normal mode. When the flashlight function is executed, white LED 60 is turned on by at least one processor 30.

For example, when icon 102 shown with an image consisting of a plurality of quadrangles is touched on home screen 100, a function to select other applications can be executed. When an icon for the flashlight function is touched in a screen in which icons indicating other applications are shown in a list on display 14 or when key 24f is operated while home screen 150 is shown on display 14, the flashlight function can be executed.

In light operation screen 500, information 502 on intensity of radio waves, a state of charge of the battery, and current time is shown in the upper right portion with an image and characters.

Icons 504, 506, 508, and 510 for operations in the normal mode are shown on light operation screen 500.

Icon 504 is a button for causing the flashlight to blink. Icon 506 is a button for turning off and on the flashlight. Specifically, when icon 506 is touched on light operation screen 500, the flashlight is turned off and representation of icon 506 is changed to “ON”. Thereafter, when icon 506 is touched, the flashlight is turned on and representation of icon 506 is changed to “OFF”. Icon 508 is a button for increasing brightness of (lighting up) the flashlight. Icon 510 is a button for decreasing brightness of (dimming) the flashlight. By touching icons 508 and 510, brightness can be adjusted between highest brightness and lowest brightness.

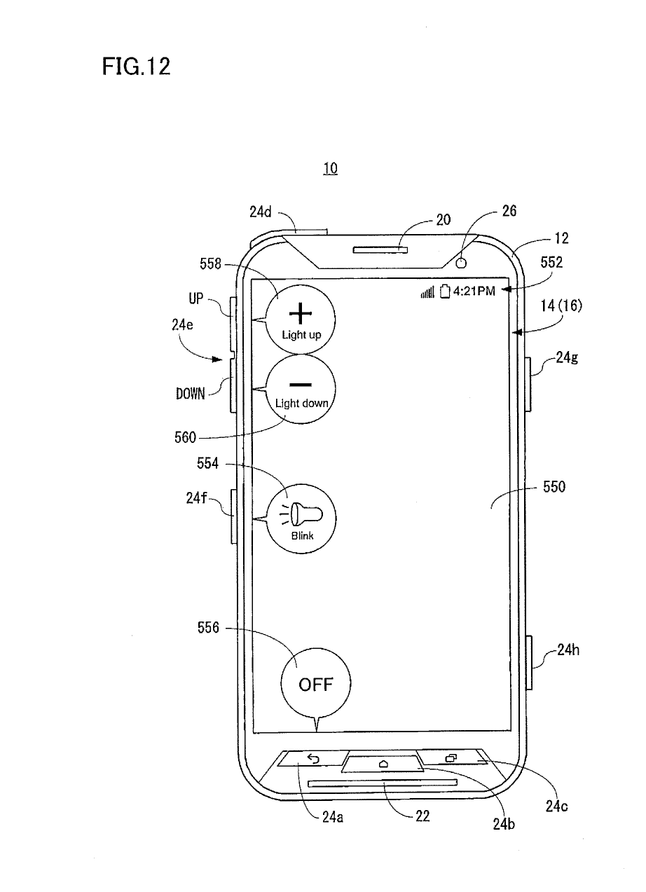

FIG. 12 shows one example of a light operation screen 550 shown on display 14 when the flashlight function is executed in the underwater mode. When the flashlight function is executed as in the normal mode, at least one processor 30 turns on white LED 60.

In the underwater mode, a function to cause the flashlight to blink is allocated to key 24f. A function to turn off and on the flashlight is allocated to key 24a. A function to increase brightness of (lighting up) the flashlight is allocated to the UP key of key 24e. A function to decrease brightness of (dim) the flashlight is allocated to the DOWN key of key 24e.

Therefore, in light operation screen 550 shown in FIG. 12, guide images 554, 556, 558, and 560 for notification of functions allocated to key 24a, key 24e, and key 24f are shown. Since guide images 554 to 560 are similar to guide images 504 to 510 described in connection with home screen 150, redundant description will not be provided.

When key 24a is pressed on light operation screen 550 as in the normal mode, the flashlight is turned off and representation of guide image 556 is changed to “ON”. Thereafter, when key 24a is pressed, the flashlight is turned on and representation of guide image 556 is changed to “OFF”.

In light operation screen 550 as well, information 552 on intensity of radio waves, a state of charge of the battery, and current time is shown in the upper right portion of the screen with an image and characters as in light operation screen 500 in the normal mode.

In light operation screen 550 as well, a message informing that the mode is set to the underwater mode, for example, message 152 indicating an operation under water (Underwater Operation) and indicating that an operation is to be performed with a hardware key (Please operate it with a hardware key) shown in FIG. 4, may be shown.

Thus, in accordance with functions (applications) to be executed, functions (operation contents or instruction contents) allocated to hardware keys (24a to 24f and 24h) are different in the underwater mode. In this example, however, a function of key 24g (on and off of a main power supply) is fixed.

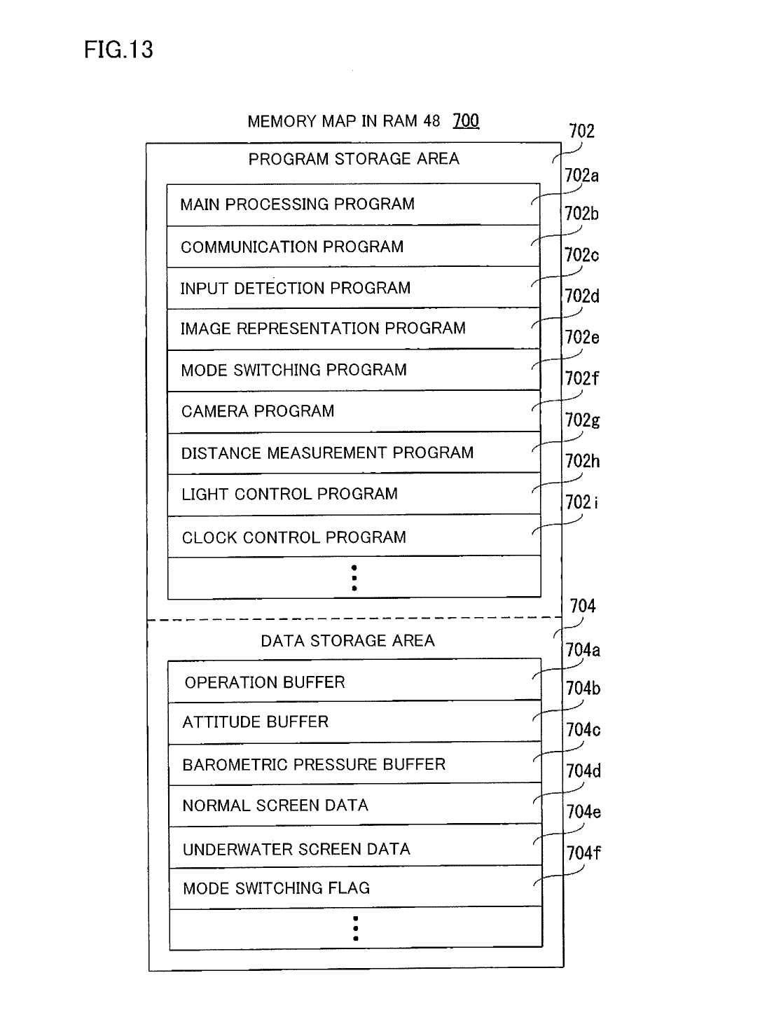

FIG. 13 illustrates one example of a memory map 700 in RAM 48 shown in FIG. 2. As shown in FIG. 13, RAM 48 can include a program storage area 702 and a data storage area 704. In program storage area 702, a control program for portable telephone 10 and programs for various functions (applications) can be stored. Specifically, in program storage area 702, a main processing program 702a, a communication program 702b, an input detection program 702c, an image representation program 702d, a mode switching program 702e, a camera program 702f, a distance measurement program 702g, a light control program 702h, and a clock control program 702i can be stored.

Main processing program 702a is a program configured to process a main routine of portable telephone 10. Communication program 702b is a program configured to place a call with another telephone or communicate data with another telephone or computer.

Input detection program 702c is a program configured to have coordinate data, key data, a GPS signal, angular velocity data, acceleration data, and an electric signal indicating variation in electrical resistance which are input (output) from various input modules or sensors such as touch panel 16, input device 42, GPS circuit 54, attitude sensor 62, and pressure sensor 64 stored in data storage area 704. An electric signal output from pressure sensor 64 can be stored in data storage area 704 after it is converted into a barometric pressure value (a water pressure value).

Image representation program 702d is a program configured to generate display screen data corresponding to various screens (100, 150, 200, 250, 300, 350, 400, 450, 500, and 550) with the use of normal screen data 704d or underwater screen data 704e which will be described later and to output the display screen data to display 14.

Mode switching program 702e is a program configured to switch between the normal mode and the underwater mode based on a detected barometric pressure value (water pressure value). Camera program 702f is a program configured to shoot a still image or moving images by using inner camera 26 or outer camera 52. Distance measurement program 702g is a program configured to measure a distance by using infrared sensor 58.

Light control program 702h is a program configured to turn on and off the flashlight, to cause the flashlight to blink, or to adjust brightness of the flashlight with the use of white LED 60. Clock control program 702i is a program configured to show current time, execute an alarm function, or execute a stopwatch function.

Though not shown, in program storage area 702, other programs for executing functions of portable telephone 10 can also be stored.

Data storage area 704 may include an operation buffer 704a, an attitude buffer 704b, and a barometric pressure buffer 704c. In data storage area 704, normal screen data 704d and underwater screen data 704e can be stored. Data storage area 704 may include a mode switching flag 704f.

Operation buffer 704a can store coordinate data from touch panel 16 and key data from input device 42 in a time-series manner. Attitude buffer 704b can store angular velocity data and acceleration data from attitude sensor 62 as attitude data in a time-series manner. Barometric pressure buffer 704c can store data on a barometric pressure value (a water pressure value) resulting from conversion of an output from pressure sensor 64 in a time-series manner.

Data stored in operation buffer 704a, attitude buffer 704b, and barometric pressure buffer 704c can be deleted (erased) after it is used for processing by at least one processor 30.

Normal screen data 704d is data configured to generate display screen data for various screens (100, 200, 300, 400, and 500) shown in the normal mode.

Underwater screen data 704e is data configured to generate display screen data for various screens (150, 250, 350, 450, and 550) shown in the underwater mode.

Mode switching flag 704f is a flag for identifying the normal mode and the underwater mode. For example, mode switching flag 704f is turned off in the normal mode and it is turned on in the underwater mode.

In data storage area 704, other data necessary for execution of a control program or an application program can be stored, other flags can be located, or a timer (a counter) can be located.

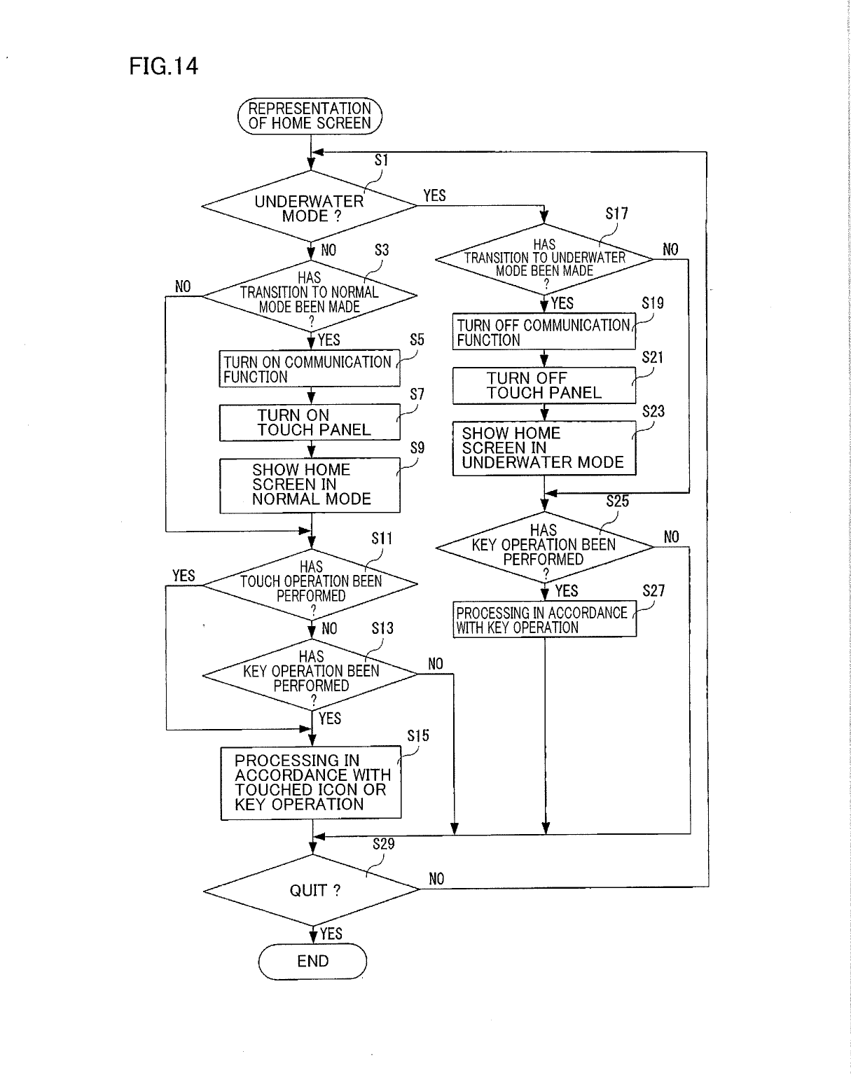

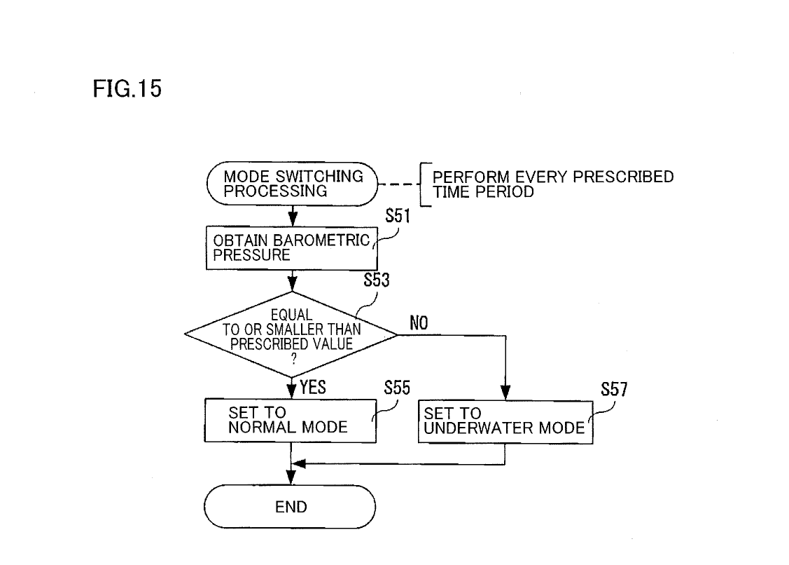

FIG. 14 is a flowchart showing one example of home screen representation processing by at least one processor 30 shown in FIG. 2. In parallel to the home screen representation processing, mode switching processing (FIG. 15) which will be described later can be performed. Though not shown, operation data detection processing, attitude detection processing, and barometric pressure detection processing can be performed in parallel to such processing.

At least one processor 30 can perform a plurality of tasks in parallel under the control by an OS based on Windows™ or other OSs such as an OS based on Linux™ including Android™ and iOS™.

In operation data detection processing, at least one processor 30 can have operation data (coordinate data and key data) input from touch panel 16 or input device 42 stored in operation buffer 704a in a time-series manner. In attitude detection processing, at least one processor 30 can have angular velocity data and acceleration data from attitude sensor 62 stored in attitude buffer 704b as attitude (inclination or motion) data in a time-series manner. In barometric pressure detection processing, at least one processor 30 can convert an output from pressure sensor 64 into a barometric pressure value (a water pressure value) and have the resultant data of the barometric pressure value (barometric pressure data) stored in barometric pressure buffer 704c in a time-series manner.

As shown in FIG. 14, as the home screen representation processing is started, whether or not the underwater mode is set can be determined in step S1. At least one processor 30 can determine whether or not mode switching flag 704f is on.

When determination as “YES” is made in step S1, that is, when the underwater mode is set, the process proceeds to step S17. When determination as “NO” is made in step S1, that is, when the normal mode is set, whether or not transition from the underwater mode to the normal mode has been made can be determined in step S3. At least one processor 30 can determine whether or not mode switching flag 704f has been changed from on to off.

When determination as “NO” is made in step S3, that is, when the normal mode continues, the process proceeds to step S11. When determination as “YES” is made in step S3, that is, when transition from the underwater mode to the normal mode has been made, a communication function can be turned on in step S5. At least one processor 30 can start supply of power to components (radio communication circuit 32 and GPS circuit 54) for a call and data communication.

In step S7, touch panel 16 can be turned on. At least one processor 30 can instruct touch panel control circuit 50 to start supply of power to touch panel 16. In step S9, display driver 44 can be controlled to have display 14 show home screen 100 in the normal mode as shown in FIG. 3 and the process proceeds to step S11.

Whether or not a touch operation has been performed can be determined in step S11. At least one processor 30 can determine whether or not coordinate data of a current frame is stored in operation buffer 704a. When determination as “YES” is made in step S11, that is, when a touch operation has been performed, the process proceeds to step S15. When determination as “NO” is made in step S11, that is, when a touch operation has not been performed, whether or not a key operation has been performed can be determined in step S13. At least one processor 30 can determine whether or not key data of a current frame is stored in operation buffer 704a.

When determination as “NO” is made in step S13, that is, when a key operation has not been performed, the process proceeds to step S29. When determination as “YES” is made in step S13, that is, when a key operation has been performed, processing in accordance with a touched icon or a key operation can be performed in step S15 and the process proceeds to step S29. Here, a function (an application) allocated to touched icon 102 can be executed or a function allocated to keys 24a to 24h can be executed. Since the processing in step S15 is the same as in conventional portable telephone 10, detailed description will not be provided. When a function (an application) other than processing shown on home screen 100 is to be executed, a screen for executing the function can be shown and the home screen representation processing can be force-quitted. When key 24g is long-tapped, a main power supply of portable telephone 10 is turned off and hence the home screen representation processing can be force-quitted. This is also applicable to step S27 which will be described later.

As described above, in the underwater mode, determination as “YES” is made in step S1 and whether or not transition from the normal mode to the underwater mode has been made can be determined in step S17. At least one processor 30 can determine whether or not mode switching flag 704f has been changed from off to on.

When determination as “NO” is made in step S17, that is, when the underwater mode continues, the process proceeds to step S25. When determination as “YES” is made in step S17, that is, when transition from the normal mode to the underwater mode has been made, the communication function can be turned off in step S19. At least one processor 30 can stop supply of power to components for a call and data communication.

Touch panel 16 can be turned off in step S21. Under instructions from at least one processor 30, touch panel control circuit 50 can stop supply of power to touch panel 16. In step S23, display driver 44 can be controlled to have display 14 show home screen 150 in the underwater mode as shown in FIG. 4 and the process proceeds to step S25.

Whether or not a key operation has been performed can be determined in step S25. At least one processor 30 can determine whether or not key data of a current frame is stored in operation buffer 704a. When determination as “NO” is made in step S25, that is, when a key operation has not been performed, the process proceeds to step S29. When determination as “YES” is made in step S25, that is, when a key operation has been performed, processing in accordance with the key operation can be performed in step S27 and the process proceeds to step S29. In step S27, as described above, when the UP key is operated, at least one processor 30 can execute the stopwatch function, and when the DOWN key is operated, at least one processor 30 can execute the distance measurement function. When key 24f is operated, the flashlight function can be executed. When key 24g is operated (tapped), the backlight can be turned off. When key 24g is operated (long-tapped), the main power supply can be turned off. When key 24h is operated, the camera function can be executed. When a function (an application) other than processing shown on home screen 150 is to be executed, a screen for executing the function can be shown and the home screen representation processing can be force-quitted. When the backlight of display 14 is turned off, portable telephone 10 is set to a sleep state.

Whether or not the process is to be quitted can be determined in step S29. At least one processor 30 can determine whether or not key 24g has been tapped and whether or not the backlight of display 14 has been turned off. When determination as “NO” is made in step S29, that is, when the process is not to be quitted, the process returns to step S1. When determination as “YES” is made in step S29, that is, when the process is to be quitted, the home screen representation processing can end. Thereafter, for example, portable telephone 10 is set to the sleep state.

FIG. 15 is a flowchart showing one example of the mode switching processing by at least one processor 30. When the main power supply of portable telephone 10 is turned on, the mode switching processing can be performed every prescribed time period (for example, 10 seconds). When portable telephone 10 is in the sleep state, the mode switching processing does not have to be performed.

As shown in FIG. 15, when at least one processor 30 starts the mode switching processing, it can obtain a barometric pressure in step S51. At least one processor 30 can obtain a barometric pressure value (a water pressure value) of a current frame by referring to barometric pressure buffer 704c.

In step S53, whether or not a barometric pressure value is equal to or smaller than a prescribed value (for example, a value corresponding to a standard atmospheric pressure) can be determined. When determination as “YES” is made in step S53, that is, when the barometric pressure value is equal to or smaller than the prescribed value, portable telephone 10 is determined to be in atmosphere, the normal mode is set in step S55, and the mode switching processing can end. In step S55, at least one processor 30 can turn off mode switching flag 704f. When determination as “NO” is made in step S53, that is, when the barometric pressure value exceeds the prescribed value, the underwater mode can be set in step S57 and the mode switching processing can end. In step S57, at least one processor 30 can turn on mode switching flag 704f.

In this example, when the barometric pressure value is equal to or smaller than a prescribed value or exceeds the prescribed value, the normal mode or the underwater mode is immediately set, however, limitation thereto does not have to be placed. There is also a detection error of pressure sensor 64. Therefore, the normal mode or the underwater mode may be set when a time period during which a barometric pressure value is not greater than a prescribed value continues for a prescribed time period or when a time period during which a barometric pressure value exceeds a prescribed value continues for a prescribed time period.

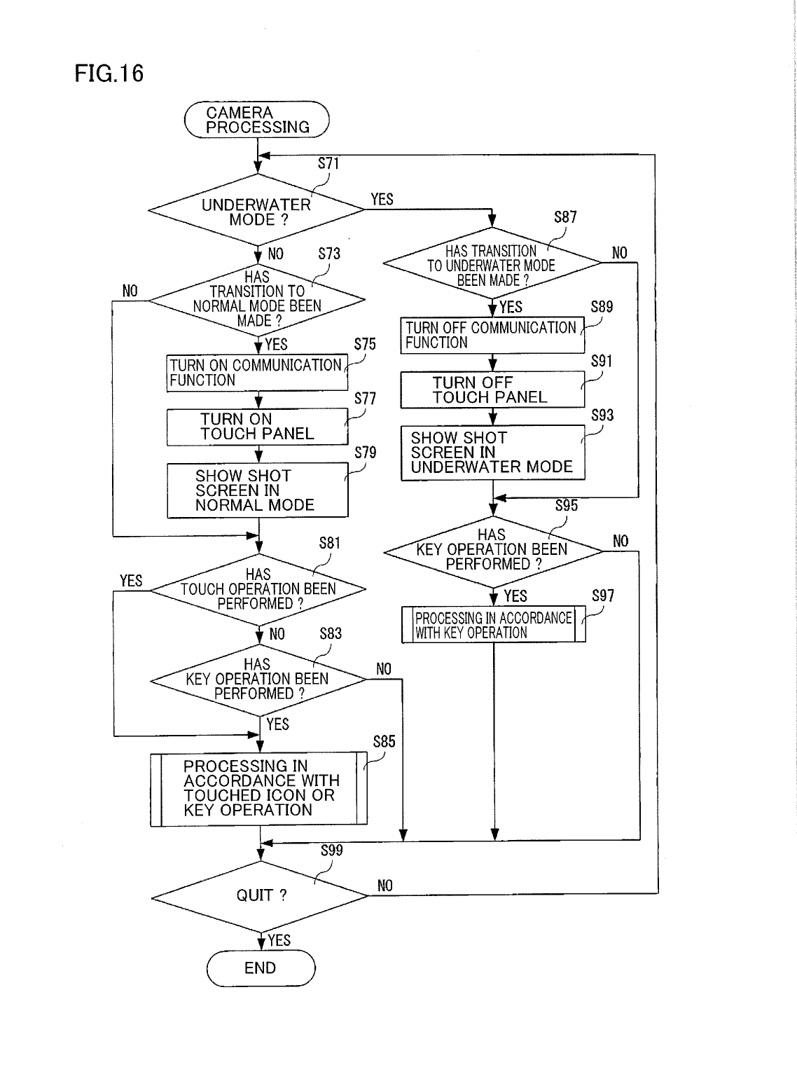

FIG. 16 is a flowchart showing one example of the camera processing by at least one processor 30 shown in FIG. 2. When icon 102 for the camera application is touched while home screen 100 is shown or when key 24h is operated while home screen 100 or home screen 150 is shown, the camera application is executed and the camera processing is started. Though the camera processing will be described below with reference to FIG. 16, processing the same as in the home screen representation processing described previously will briefly be described.

As shown in FIG. 16, when at least one processor 30 starts the camera processing, it can determine in step S71 whether or not the underwater mode is set. When determination as “YES” is made in step S71, the process proceeds to step S87. When determination as “NO” is made in step S71, whether or not transition from the underwater mode to the normal mode has been made can be determined in step S73.

When determination as “NO” is made in step S73, the process proceeds to step S81. When determination as “YES” is made in step S73, the communication function can be turned on in step S75 and touch panel 16 can be turned on in step S77. In step S79, display driver 44 can be controlled to have display 14 show shot screen 200 in the normal mode as shown in FIG. 5 and the process proceeds to step S81.

Whether or not a touch operation has been performed can be determined in step S81. When determination as “YES” is made in step S81, the process proceeds to step S85. When determination as “NO” is made in step S81, whether or not a key operation has been performed can be determined in step S83.

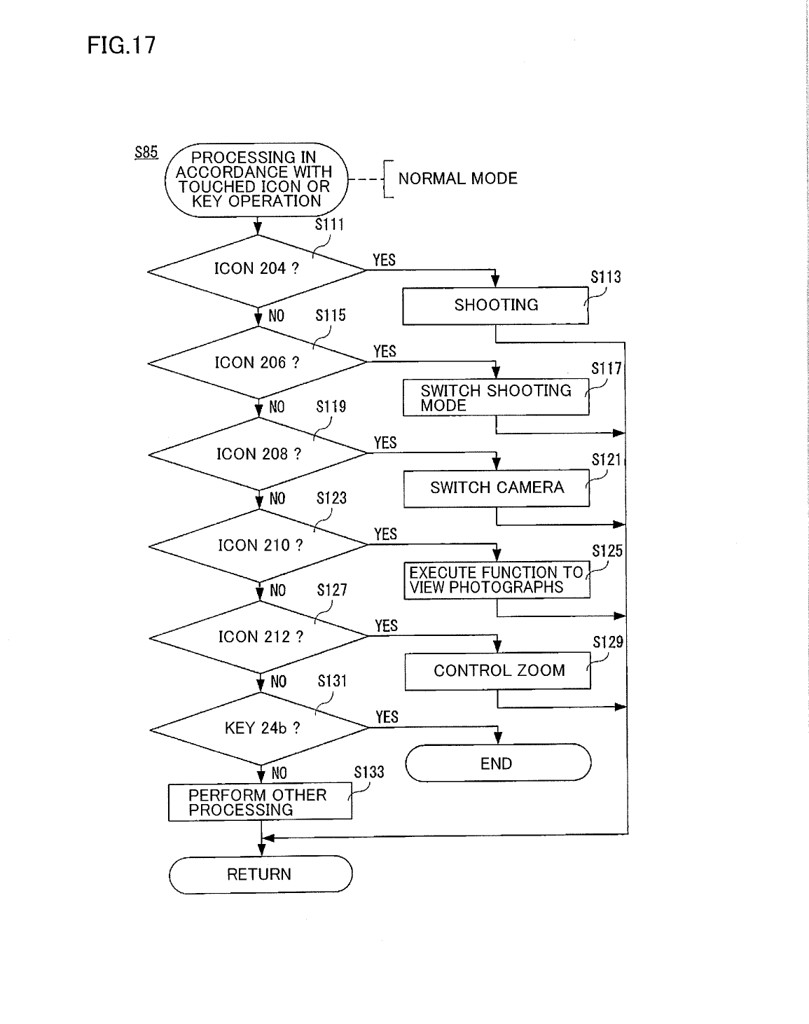

When determination as “NO” is made in step S83, that is, when a key operation has not been performed, the process proceeds to step S99. When determination as “YES” is made in step S83, that is, when a key operation has been performed, processing in accordance with a touched icon or a key operation (see FIG. 17) which will be described later can be performed in step S85 and the process proceeds to step S99.

As described above, when determination as “YES” is made in step S71, whether or not transition from the normal mode to the underwater mode has been made can be determined in step S87. When determination as “NO” is made in step S87, the process proceeds to step S95. When determination as “YES” is made in step S87, the communication function can be turned off in step S89 and touch panel 16 can be turned off in step S91. In step S93, display driver 44 can be controlled to have display 14 show shot screen 250 in the underwater mode as shown in FIG. 6 and the process proceeds to step S95.

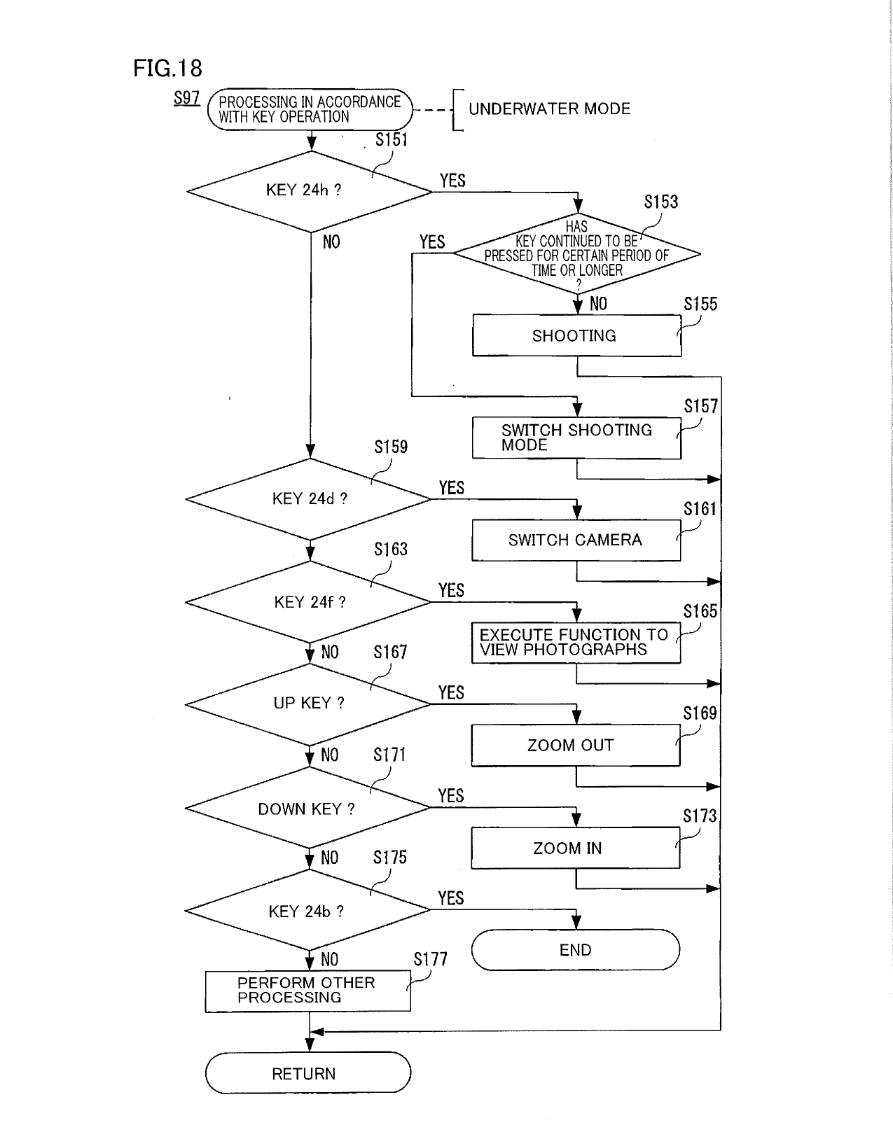

Whether or not a key operation has been performed can be determined in step S95. When determination as “NO” is made in step S95, the process proceeds to step S99. When determination as “YES” is made in step S95, the processing in accordance with the key operation (see FIG. 18) which will be described later can be performed in step S97 and the process proceeds to step S99.

Whether or not the process is to be quitted can be determined in step S99. At least one processor 30 can determine whether or not key 24b has been tapped and whether or not representation of home screen 100 or home screen 150 has been indicated. When determination as “NO” is made in step S99, that is, when the process is not to be quitted, the process returns to step S71. When determination as “YES” is made in step S99, that is, when the process is to be quitted, the camera processing can end. At least one processor 30 can perform the home screen representation processing and home screen 100 or home screen 150 is shown on display 14 of portable telephone 10.

FIG. 17 is a flowchart showing one example of processing in accordance with a touched icon or a key operation in step S85 shown in FIG. 16. As shown in FIG. 17, when at least one processor 30 starts processing, it can determine whether or not icon 204 has been touched in step S111.

When determination as “YES” is made in step S111, that is, when icon 204 has been touched, shooting processing can be performed in step S113 and the process can return to the camera processing shown in FIG. 16. When determination as “NO” is made in step S111, that is, when icon 204 has not been touched, whether or not icon 206 has been touched can be determined in step S115.

Though not shown in the flowchart, in the mode for shooting moving images, shooting of moving images can be started by touching icon 204, and shooting of moving images can end by subsequently touching icon 204. For icon 204, before shooting of moving images is indicated, a graphic (a picture) or characters for notification of start of shooting of moving images or both of them may be shown. For icon 204, during shooting of moving images, a graphic (a picture) or characters for notification of end of shooting of moving images or both of them may be shown.

When determination as “YES” is made in step S115, that is, when icon 206 has been tapped, the shooting mode can be switched in step S117 and the process can return to the camera processing. When the current shooting mode is set to a mode for shooting a still image, the shooting mode can be switched to a mode for shooting moving images as icon 206 is touched. When the current shooting mode is set to a mode for shooting moving images, the shooting mode can be switched to a mode for shooting a still image as icon 206 is touched. When determination as “NO” is made in step S115, that is, when icon 206 has not been touched, whether or not icon 208 has been touched can be determined in step S119.

When determination as “YES” is made in step S119, that is, when icon 208 has been touched, the camera is switched in step S121 and the process can return to the camera processing. When icon 208 has been touched while inner camera 26 is used, at least one processor 30 can inactivate inner camera 26 and activate outer camera 52 in step S121. When icon 208 has been touched while outer camera 52 is used, at least one processor 30 can inactivate outer camera 52 and activate inner camera 26. When determination as “NO” is made in step S119, that is, when icon 208 has not been touched, whether or not icon 210 has been touched can be determined in step S123.

When determination as “YES” is made in step S123, that is, when icon 210 has been touched, a function to view photographs can be executed in step S125 and the process can return to the camera processing. The function to view photographs is a function for viewing a shot image or an obtained image. Here, the camera function (camera processing) is suspended and the camera function is resumed after the function to view photographs ends. When determination as “NO” is made in step S123, that is, when icon 210 has not been touched, whether or not icon 212 has been touched is determined in step S127.

When determination as “YES” is made in step S127, that is, when icon 212 has been touched, zoom can be controlled in step S129 and the process can return to the camera processing. In step S129, at least one processor 30 can control zoom in accordance with a position of slide button 212a. When slide button 212a is moved toward +, an image can be zoomed in. When slide button 212a is moved toward −, an image can be zoomed out. When determination as “NO” is made in step S127, that is, when icon 212 has not been touched, whether or not key 24b has been operated is determined in step S131.

When determination as “YES” is made in step S131, that is, when key 24b has been operated, the camera processing can end and the screen can return to the home screen. The home screen representation processing shown in FIG. 14 is started. When determination as “NO” is made in step S131, that it, when key 24b has not been operated, processing in accordance with an operation of other keys 24a and 24c to 24h can be performed in step S133 and the process can return to the camera processing. When key 24g is long-tapped, the camera processing can be force-quitted and the main power supply of portable telephone 10 can be turned off.

FIG. 18 is a flowchart showing one example of processing in accordance with a key operation in step S97 shown in FIG. 16. Though the processing will be described below, processing the same as described in connection with the processing in accordance with a touched icon or a key operation will briefly be described.

As shown in FIG. 18, when processing in accordance with a key operation is started, at least one processor 30 can determine in step S151 whether or not key 24h has been operated (pressed).

When determination as “YES” is made in step S151, that is, when key 24h has been operated, whether or not the key continues to be pressed for a certain time period or longer can be determined in step S153. When determination as “NO” is made in step S153, that is, when key 24h has been operated for a time period shorter than the certain time period, shooting processing can be performed in step S155 and the process can return to the camera processing shown in FIG. 16. When determination as “YES” is made in step S153, that is, when key 24h continues to be pressed for a certain time period or longer, the shooting mode can be switched in step S157 and the process can return to the camera processing.

Though not shown in the flowchart, when the mode for shooting moving images has been set, shooting of moving images can be started by operating key 24h for a time period shorter than a certain time period. Thereafter, shooting of moving images can be quitted by similarly operating key 24h for a time period shorter than the certain time period. For guide image 254, before shooting of moving images is indicated, a graphic (a picture) or characters for notification of start of shooting of moving images or both of them may be shown. For guide image 254, during shooting of moving images, a graphic (a picture) or characters for notification of end of shooting of moving images or both of them may be shown.

When determination as “NO” is made in step S151, that is, when key 24h has not been operated, whether or not key 24d has been operated can be determined in step S159. When determination as “YES” is made in step S159, that is, when key 24d has been operated, the camera can be switched in step S161 and the process can return to the camera processing. When determination as “NO” is made in step S159, that is, when key 24d has not been operated, whether or not key 24f has been operated can be determined in step S163.

When determination as “YES” is made in step S163, that is, when key 24f has been operated, a function to view photographs can be performed in step S165 and the process can return to the camera processing. When determination as “NO” is made in step S163, that is, when key 24f has not been operated, whether or not the UP key has been operated can be determined in step S167.

When determination as “YES” is made in step S167, that is, when the UP key has been operated, an image can be zoomed out in step S169 and the process can return to the camera processing. When an image has been zoomed out to a maximal extent, the image will not be zoomed out in spite of operation of the UP key. When determination as “NO” is made in step S167, that is, when the UP key has not been operated, whether or not the DOWN key has been operated can be determined in step S171.

When determination as “YES” is made in step S171, that is, when the DOWN key has been operated, an image can be zoomed in and the camera can be controlled in step S173, and the process can return to the camera processing. When an image has been zoomed in to a maximal extent, the image will not be zoomed in in spite of operation of the DOWN key. When determination as “NO” is made in step S171, that is, when the DOWN key has not been operated, whether or not key 24b has been operated can be determined in step S175.

When determination as “YES” is made in step S175, that is, when key 24b has been operated, the camera processing can end and the screen can return to the home screen. When determination as “NO” is made in step S175, that is, when key 24b has not been operated, processing in accordance with an operation of other keys 24a, 24c, and 24g can be performed in step S177 and the process can return to the camera processing.

Though the camera processing alone is described with reference to the flowcharts, description is also the same for the stopwatch, distance measurement, and flashlight functions. In the underwater mode, functions different from those in the normal mode are allocated to some of keys (24a to 24h), the different function is shown with a guide image, and the function allocated to the key (24a to 24h) can be performed by an operation of a key (24a to 24h) by a user.

According to this example, for functions executable even under water, a function for underwater operation is allocated to a hardware key, and a guide image showing the allocated function is shown in correspondence with the hardware key. Therefore, an operation of a key is facilitated even in underwater use. Namely, operability can be improved.

In the example, though a screen to be shown is varied between the normal mode and the underwater mode based on detection of a barometric pressure (a water pressure), limitation thereto does not have to be placed.

In other examples, under water, variation in water pressure value may be detected and a screen in accordance with a water pressure may be shown. In such a case, for example, when a water depth is relatively small, a flashlight function is not allocated to a key (24a to 24h) with the flashlight being assumed to be unnecessary. When a water depth is large to some extent, however, the flashlight function is allocated to any key (24a to 24h) and a guide image may be shown on the home screen (150) in the underwater mode. Though a function to be allocated is added depending on a water pressure (a water depth), a function to be allocated may be deleted or interchanged.

A water depth can be calculated based on a water pressure or obtained from data in a table in which water depths are written in association with water pressures.

Instead of showing a screen in accordance with a water pressure, brightness of the screen (luminance of the backlight of display 14) may be varied. In such a case, for example, when a water depth is relatively small, natural light reaches the depth and brightness of the screen does not have to be increased. When a water depth is large to some extent, however, natural light does not reach the depth and hence brightness of the screen should be increased. Luminance of the backlight of display 14 is controlled by display driver 44 under instructions from at least one processor 30.

According to the example, pressure sensor 64 is used for detecting portable telephone 10 being under water. When pressing (tap or long tap) is detected over a wide range beyond a prescribed range on a touch panel, for example, over the entire surface of the touch panel, due to application of a water pressure onto the touch panel, portable telephone 10 being under water may be detected.

In other examples, a current position of portable telephone 10 (user) may be detected with the GPS function and a screen in accordance with the current position may be shown. For example, it is possible that a home screen different between the Sea of Japan side and the Pacific side may be shown even in the same underwater mode. Since the Sea of Japan and the Pacific are different from each other in color of water or water quality, a water depth at which the flashlight function is allocated to a key (24a to 24h) may also be differed. A current position obtained most recently before entry of portable telephone 10 into water is made use of as the current position.

Though switching between the normal mode and the underwater mode is made depending on whether or not a pressure is equal to or lower than a standard atmospheric pressure, such a criterion (threshold value) may variably be set in accordance with an altitude measured with the GPS function, because an atmospheric pressure is lower as the altitude is higher. The underwater mode can thus be set even when a user dives into a lake located at a high altitude.

In the example, though the stopwatch, the distance measurement, the flashlight, and the camera are described as examples of functions allocated to keys (24a to 24h) in the underwater mode, limitation thereto should not be placed. Portable telephone 10 is a multi-functional information terminal and a function can be added or deleted.

For example, other functions may include an emergency contact function. One example of the emergency contact function is as follows. When a key (24a to 24h) to which the emergency contact function is allocated is operated, a light (white LED 60) is turned on for notifying the surrounding of an abnormal condition. Therefore, the light may blink in accordance with a pattern for notification of an emergency. A strap serving as a float (a ring buoy) may be attached in advance to portable telephone 10, so that portable telephone 10 floats to the water surface as a user releases the strap from his/her hand. As portable telephone 10 floats to the water surface, the current position (the latitude and the longitude) is detected with the GPS function and information on the detected current position is transmitted to a predetermined destination by using the communication function (mail function). Whether or not portable telephone 10 floats to the water surface can be known based on a barometric pressure value (a water pressure value) resulting from conversion from an output from pressure sensor 64.

In the example, a function used under water is individually allocated to each hardware key, however, limitation thereto does not have to be placed. When a large number of functions are executable, the UP key and the DOWN key are used to vertically move (scroll) guide images showing the executable functions on home screen 150 so that a function associated with the guide image shown at a position corresponding to key 24f may be executed by operating key 24f.

A portable terminal according to a first manner of the present disclosure is a portable terminal provided with a waterproof function, and includes a display, a touch panel located in association with the display, at least one hardware key, and at least one processor. The portable terminal is configured to determine whether or not the portable terminal is under water and to cause the display to show a guide image for notification of a function for underwater use in correspondence with the hardware key to which the function is allocated when the portable terminal is determined to be under water.

In the first manner, the portable terminal (10) is provided with a waterproof function, and includes a display (14), a touch panel (16) located in association with the display, at least one hardware key (24a to 24h), and at least one processor (30). The at least one processor (30, S53) can determine whether or not the portable terminal is under water. For example, the portable terminal is determined to be under water when a pressure higher than an atmospheric pressure is applied. The at least one processor (30, S23, S93) can cause the display to show a guide image for notification of a function for underwater use in correspondence with the hardware key to which the function is allocated when the portable terminal is determined to be under water.

According to the first manner, since the function allocated to the hardware key is shown with a guide image when the portable terminal is used under water, the portable terminal can easily be operated even when it is used under water. Namely, operability can be improved.

The portable terminal according to a second manner of the present disclosure is dependent on the first manner, and the at least one processor is configured to cause the display to show the guide image when a function different from the function for use in atmosphere is allocated to the hardware key.

In the second manner, when a function different from the function for use in atmosphere is allocated to the hardware key, the at least one processor can cause the display to show the guide image. For a hardware key of which function is varied between the normal mode in which the portable terminal is used in atmosphere and the underwater mode, a guide image is shown when transition to the underwater mode is made. For a hardware key of which function is not varied, however, a guide image is not shown even when transition to the underwater mode is made.

According to the second manner, since a guide image is shown in correspondence with a hardware key for which guide is necessary, a user can be informed of change in function and a function after change.

The portable terminal according to a third manner of the present disclosure is dependent on the first or second manner, and a function to execute an application executable only in atmosphere is configured not to be allocated to the hardware key.

In the third manner, a function to execute an application executable only in atmosphere is not allocated to a hardware key. In the underwater mode, only a function executable under water is allocated to a hardware key.

According to the third manner, a function executable only in atmosphere is not erroneously executed under water. Power supply to a component associated with a function executable only in atmosphere is stopped in the underwater mode so that useless power consumption can also be prevented.

The portable terminal according to a fourth manner of the present disclosure is dependent on any of the first to third manners, and the at least one processor is configured to measure a water depth and to change a function allocated to the hardware key in accordance with a result of measurement.

In the fourth embodiment, the at least one processor (30, 64) is configured to measure a water depth. A function to be allocated to a hardware key is varied in accordance with a result of measurement, that is, a water depth.

According to the fourth embodiment, a necessary function can appropriately be allocated.

The portable terminal according to a fifth manner of the present disclosure is dependent on the fourth manner, and the at least one processor is configured to vary brightness of the display in accordance with the result of measurement of the water depth.

In the fifth embodiment, the at least one processor (30, 44) can vary brightness of the display in accordance with a result of measurement of a water depth. For example, since it gets dark with increase in water depth, brightness can gradually be increased.

According to the fifth manner, since the display can be set to necessary brightness, useless power consumption can be prevented.

A storage medium according to a sixth manner of the present disclosure is a processor readable storage medium having a control program stored thereon, the control program having at least one processor control a portable terminal with a waterproof function, the portable terminal including a display, a touch panel located in association with the display, and at least one hardware key. The control program is configured to have at least one processor determine whether or not the portable terminal is under water and to cause the display to show a guide image for notification of a function for underwater use in correspondence with the hardware key to which the function is allocated when the portable terminal is determined to be under water.

A control method according to a seventh manner of the present disclosure is a method of controlling a portable terminal with a waterproof function, the portable terminal including a display, a touch panel located in association with the display, and at least one hardware key. According to the control method, the at least one processor of the portable terminal is configured to determine whether or not the portable terminal is under water and to cause the display to show a guide image for notification of a function for underwater use in correspondence with the hardware key to which the function is allocated when the portable terminal is determined to be under water.

In the sixth and seventh manners as well, operability can be improved as in the first manner.

Specific numeric values, various screens, and various functions mentioned herein are mere exemplification and can be modified as appropriate depending on change in specifications of a product.

### REFERENCE SIGNS LIST

10 portable telephone; 14 display; 16 touch panel; 20 speaker; 22 microphone; 24a to 24h key; 26, 52 camera; 30 at least one processor; 46 flash memory; 48 RAM; 54 GPS circuit; 58 infrared sensor; 60 white LED; 62 attitude sensor; and 64 pressure sensor.

1. A portable terminal with a waterproof function, the portable terminal comprising:
a display;
a touch panel located in association with the display;
at least one hardware key; and
at least one processor,
the at least one processor being configured to:
determine whether the portable terminal is under water; and
cause the display to show a guide image for notification of a function for underwater use in correspondence with the hardware key to which the function is allocated, when the portable terminal is determined to be under water.

2. The portable terminal according to claim 1, wherein
the at least one processor is configured to cause the display to show the guide image when a function different from the function for use in atmosphere is allocated to the hardware key.

3. The portable terminal according to claim 1, wherein
a function to execute an application executable only in atmosphere is configured not to be allocated to the hardware key.

4. The portable terminal according to claim 1, wherein
the at least one processor is configured to measure a water depth and to change a function allocated to the hardware key in accordance with a result of measurement of the water depth.

5. The portable terminal according to claim 4, wherein
the at least one processor is configured to vary brightness of the display in accordance with the result of measurement of the water depth.

6. A method of controlling a portable terminal with a waterproof function, the portable terminal including a display, a touch panel located in association with the display, and at least one hardware key,
the at least one processor of the portable terminal being configured to:
determine whether the portable terminal is under water; and
cause the display to show a guide image for notification of a function for underwater use in correspondence with the hardware key to which the function is allocated, when the portable terminal is determined to be under water.
